(19) United States
(12) Patent Application Publication
(10) Pub. No.: US 2007/0143460 A1
(43) Pub. Date: Jun. 21, 2007

(54) Load-balancing metrics for adaptive dispatching of long asynchronous network requests

(75) Inventors: Shay Ben-David, Haifa (IL); Alexey Roytman, Yokne'am llit (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/311,790

(22) Filed: Dec. 19, 2005

(51) Int. Cl. G06F 15/173

(52) U.S. Cl. 709/223

(57) ABSTRACT

Methods and systems are provided for load-balancing a data network, which is configured with a plurality of servers for servicing client requests asynchronously, and with a network dispatcher for assigning each new request to a selected server. The servers generate metrics indicative of their currently assigned workloads. The network dispatcher receives the metrics, and allocates requests according to weighted server probabilities reflecting the servers' capabilities and the metrics. Connections with the client are thereupon terminated, and reinstated after service of the request. The servers may be weighted in accordance with their respective capabilities, and the metrics adjusted by the weights.

### BACKGROUND OF THE INVENTION

1. Field of the Invention

This invention relates to load-balancing across a collection of servers in a computer network. More particularly, this invention relates to the use of a network dispatcher to balance a load of asynchronous requests among a collection of servers in which long service tasks predominate.

2. Description of the Related Art

The meanings of certain acronyms and terminology used herein are given in Table 1.

TABLE 1

| | |
|---|---|
| CPU | Central Processing Unit |
| DNS | Domain Name Service |
| J2EE | Java 2 Enterprise Edition |
| JMS | Java Message Services |
| MDB | Message Driven Beans |
| TCP | Transmission Control Protocol |
| IP | Internet Protocol |

In many computer networks, e.g., the Internet, the workload imposed by various services, has grown to the point where a single node is unable to cope. Furthermore, asynchronous tasks that are executed by servers are becoming more prevalent in common environments, for example Message Driven Beans (MDB) and Java™ Message Services (JMS) in the J2EE™ environment. The simplest load-balancing distribution solution is to allow each client to manually choose the server it uses. There are several problems with this solution: first, configuration is required on each client. Additionally, this solution is not adaptive, nor fault tolerant.

Round robin domain name service (DNS) may be used for the same purpose, and allows the servers to publish a single name by which the service is known.

Neither of the above approaches spreads the work-load evenly among the servers.

A commonly used solution for load-balancing involves a network dispatcher, which distributes network traffic across a set of back-end servers in order to achieve scalability, reliability and fail-safe performance. This is done by forwarding client requests, which reach the network dispatcher via a single IP address, to a set of servers or clusters, which actually perform the work. Typical of this approach is the disclosure of patent document WO/2005/017719, in which a network dispatcher collects weighted “health metrics” from servers, and distributes jobs to the servers based thereon.

### SUMMARY OF THE INVENTION

The invention provides a computer-implemented method for load-balancing a data network having at least one client connectable thereto, and having a cluster of servers for servicing the client. The method is carried out by establishing a connection extending from the client to the cluster of servers, receiving a request from the client, and generating in the servers respective metrics indicative of currently assigned jobs therein. The method is further carried out responsively to the metrics by assigning weight values to the servers, and allocating the request to one of the servers according to the weight values.

The invention provides a computer software product for load-balancing a data network that has at least one client connectable thereto, and has a cluster of servers for servicing the client. The product includes a computer-readable medium in which computer program instructions are stored, which instructions, when read by a computer, cause the computer to establish a connection extending from the client to the cluster of servers, to receive a request from the client, and to receive from the servers respective metrics indicative of currently assigned jobs therein. The instructions further cause the computer, responsively to the metrics, to assign weight values to the servers, and to allocate the request to one of the servers according to the weight values for service thereof.

The invention provides a network dispatcher for load-balancing a data network that has at least one client connectable thereto and has a plurality of servers for servicing the client. The network dispatcher includes a processor operative to receive a request from the client, and to receive from the servers respective metrics indicative of currently assigned jobs therein. The network dispatcher is operative, responsively to the metrics, to assign weight values to the servers, and to allocate the request to one of the servers according to the weight values for service thereof.

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram of a computer network system that is operable in accordance with a disclosed embodiment of the invention;

FIG. 2 is a detailed block diagram illustrating a server in the system shown in FIG. 1 in accordance with a disclosed embodiment of the invention;

FIG. 3. is a flow chart illustrating a method of load-balancing a data network in accordance with a disclosed embodiment of the invention;

FIG. 4 is a flow chart illustrating a method of distributing new requests using the load balancing method shown in FIG. 3, in accordance with a disclosed embodiment of the invention;

FIG. 5 shows job distribution graphs of servers being operated in an example in which the server weights are constant, according to the prior art;

FIG. 6 shows job distribution graphs of servers being operated in an example illustrating the principles of the present invention in which the server weights are adaptively varied; and

FIG. 7 shows job distribution graphs of servers being operated in an example illustrating the principles of the present invention in which the server weights are adjusted based on respective numbers of jobs being serviced.

### DETAILED DESCRIPTION OF THE INVENTION

In the following description, numerous specific details are set forth in order to provide a thorough understanding of the present invention. It will be apparent to one skilled in the art, however, that the present invention may be practiced without these specific details. In other instances, well-known circuits, control logic, and the details of computer program instructions for conventional algorithms and processes have not been shown in detail in order not to obscure the present invention unnecessarily.

Software programming code, which embodies aspects of the present invention, is typically maintained in permanent storage, such as a computer readable medium. In a client-server environment, such software programming code may be stored on a client or a server. The software programming code may be embodied on any of a variety of known media for use with a data processing system. This includes, but is not limited to, magnetic and optical storage devices such as disk drives, magnetic tape, compact discs (CD's), digital video discs (DVD's), and computer instruction signals embodied in a transmission medium with or without a carrier wave upon which the signals are modulated. For example, the transmission medium may include a communications network, such as the Internet. In addition, while the invention may be embodied in computer software, the functions necessary to implement the invention may alternatively be embodied in part or in whole using hardware components such as application-specific integrated circuits or other hardware, or some combination of hardware components and software.

Overview

Turning now to the drawings, reference is initially made to FIG. 1, which is a block diagram of a system 10 that is operable in accordance with a disclosed embodiment of the invention. A data network 12, which can be the Internet, links any number of clients 14 to a network dispatcher 16, which in turn is linked to a plurality of servers 18. For example, when the data network 12 is the Internet, the network dispatcher 16 is typically a TCP connection router that supports load sharing across the servers 18. Load sharing is supported by a process in the network dispatcher 16 that monitors the load on the servers 18 and controls a connection allocation algorithm with the clients 14.

The servers 18 each have at least one task or job queue. The length of the queue measures the number of currently pending and executing jobs or tasks. For example, when the job queue of a server has a length of five, there are five jobs remaining to be completed before the server can become idle. The servers 18 may contain a metrics generator 20. The role of the generator is to supply measurements of the server's load. The servers 18 are also provided with memory that contains objects corresponding to the functional blocks depicted in FIG. 1. The metrics generator 20 typically executes in the memory. Alternatively, the metrics generator 20 can be realized as firmware, or as hardware devices that are adapted for generating performance metrics.

Conventionally, a network dispatcher uses an adaptive load-balancing algorithm, referencing several variables to better balance the load among the servers. Typical variables are network bandwidth, request rate, number of open connections, dummy request handling time, and feedback from the servers. These are exemplary metrics that describe the load of the servers 18, such as central processing unit load and memory usage. However, in environments in which asynchronous request processing is used, these algorithms are not effective.

A persistent connection between a client and a server is not necessary in order to service an asynchronous request. Upon receipt by the server of an asynchronous request from the client, the server checks the validity of the request, enqueues the request, and advises the client that the request was accepted. Thereupon, the server generally closes its connection with the client. Normally the connection is closed as soon as the request is accepted by the server or the network dispatcher, possibly even before the server begins actual service of the request. In any case, the connection with the client is closed prior to completion of service of the request. The server notifies the client by known techniques when the job is completed, at which time the connection should be reinstated.

Asynchronous requests waiting in server queues do not influence a server's CPU load, and have negligible effect on its memory usage. These characteristics render conventional load-balancing metrics ineffective to describe the true load on the servers when asynchronous requests predominate. In this situation, as long as there are requests in process, the CPU of a working server is generally saturated at 100 per cent load, regardless of the state of the queue of pending requests. When there are no more requests to be handled, the CPU load drops, ideally to zero. Using the number of active connections per server as a metric is also misleading, since, as explained above, pending and executing requests are not generally associated with open connections. In an extreme case, all client-server connections are closed. Nevertheless, a server may be operating at full capacity, and have a long queue of pending requests.

Another conventional metric used in load-balancing is the rate of forwarded requests. However, this metric was designed for a web server environment. The work of web servers is characterized by a large number of short requests. Therefore, the mean request handling time statistically depends on the web server hardware and the number of currently pending requests. It is not significantly affected by actual request details. In contrast, in a typical asynchronous scenario, there are relatively few requests, and these are mostly associated with long jobs. An assumption by a network dispatcher of mean job execution time cannot help, due to a large statistical variation in job length in typical operations. Even if the rate of forwarded requests is perfectly known along with exact details of every, the performance of each server remains uncertain and might vary in time. Thus, load allocation decisions based only on job characteristics are inherently prone to uneven server workload distribution.

Yet another conventional approach to load-balancing involves the use of “advisors”, which are dummy requests sent by the network dispatcher to the servers. The network dispatcher measures the round trip delay, that is the time it takes the server to respond in some way to the request, e.g., to acknowledge the request. This time is of course not dependent on the number of pending requests. However, this approach can only differentiate idle from working servers: In the case of an idle server, the advisor's response time would be lower than that of a working server.

The present invention provides systems and methods in which a network dispatcher is configured to evenly distribute a workload imposed by asynchronous requests on a plurality of servers using specialized metrics.

Network Dispatcher Metric.

The inventors have developed a metric mechanism for use in a network dispatcher that returns the status of queues of pending requests in a plurality of servers. This metric is used as a measure of the real server load, alternatively or additionally to conventional metrics of CPU load and memory usage.

Continuing to refer to FIG. 1, in its simplest form, the network dispatcher 16 can initially allocate the incoming requests from the clients 14 according to fixed percentages among the servers 18. This is done by initially assigning each of the servers 18 a weight value, referred to herein as a “weight”, which is proportional to its capability. The performance of each server can be determined by known benchmark procedures. The assignment decisions are made probabilistically, according to the assigned weights. Depending on the environment, factors such as the number and speed of CPU's, total throughput, scalability, and transactions processed per second may be taken into consideration when assigning server weights. However, this mechanism does not provide feedback to adapt the benchmarks to varying situations. Therefore, further load-balancing becomes necessary, which involves adjustments to the assigned weights.

In order to distribute the work load evenly among the servers under varying conditions, a feedback mechanism is needed. Typically, the feedback mechanism adapts the weights assigned to the servers 18 according to their current loads. This load is computed based on the values returned by the metrics generator 20. As noted above, several conventional feedback mechanisms are available to the network dispatcher 16, but they do not work properly in the context of a totality or even a predominance of asynchronous requests.

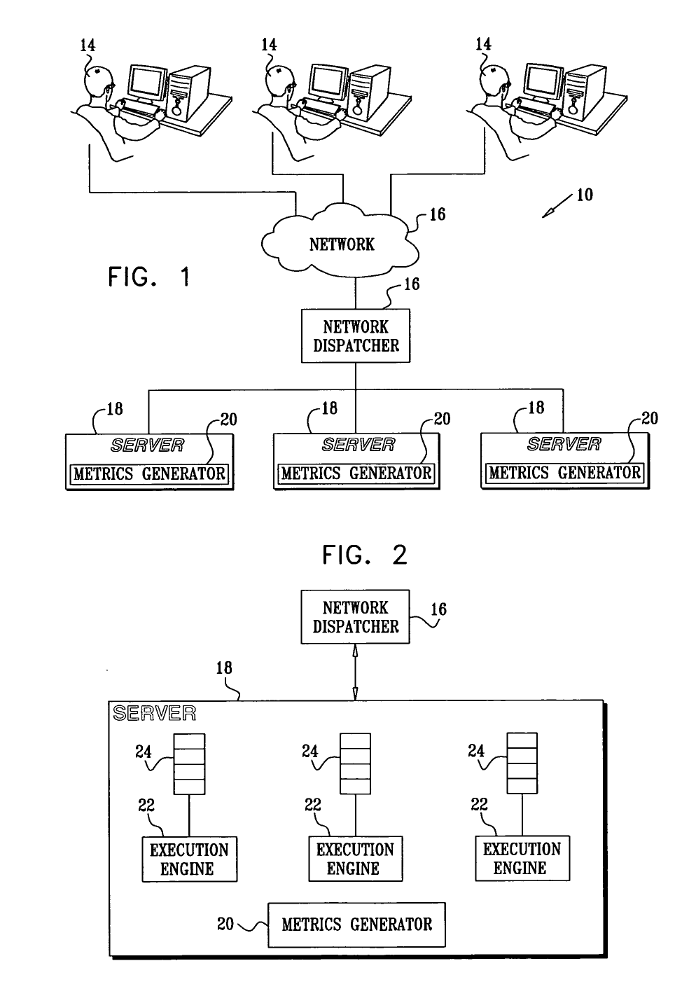

Reference is now made to FIG. 2, which is a detailed block diagram illustrating one of the servers 18 (FIG. 1) in accordance with a disclosed embodiment of the invention. Any number of execution engines 22 may operate concurrently in the server, each having job or task queues 24. Output of one execution engine may be directed to a queue belonging to another execution engine. In this embodiment the metrics generator 20 generates a metric for use by the network dispatcher 16, which is a function of the status of the queues 24 and the execution engines 22, and which appropriately reflects the respective actual load of the respective servers 18. The metric is then included by the network dispatcher 16 in its decisional logic. For example, the network dispatcher 16 may repeatedly execute a program on the servers 18 that returns the actual server load, e.g., normalized to a range of 0-100. The metrics generated by the metrics generator 20 are input parameters for a procedure that assigns weights to the servers. API's for accessing queue status and application activity are provided in standard operating systems and in environments such as JMS. Using the information returned by the servers 18, the network dispatcher 16 determines routings for new requests by taking into consideration respective current loads and assigned weights of the servers 18. In some embodiments, the assigned weights of the servers 18 are adjusted according to the information returned by the metrics generator 20, i.e., the higher the current load, the lower its weight.

In one embodiment, the load function simply returns the number of jobs the server is currently handling (both executing and pending).

In another embodiment, a more refined load function involves a combination or function of the job queue length: each of a plurality of execution engines operating within a server is assigned a workload weight, which is indicative of the amount of server resources consumed by the engine. The function can be linear or non-linear.

When server applications use standard queuing mechanisms, e.g., JMS MDB's, the status of job queues can be determined independently of the applications running on the server. The server load is calculated as the sum across the number of jobs waiting for a specified engine times its weight.

$$L = {\sum }_{i} {J}_{i} {w}_{i} , \qquad ( 1 )$$

where:

L is server load;

Jᵢ is the number of jobs assigned to (pending or running) on the i^{th} execution engine of the server; and

wᵢ is the weight assigned to the i^{th} execution engine.

The values returned by this load function are normalized, as described above, or otherwise limited to a predetermined range, set by the network dispatcher 16, and are used to derive a metric, as explained in further detail hereinbelow. Alternatively, the value returned by the function may be divided by the number of available CPU's in the server.

$$L = \frac{{\sum }_{i} {J}_{i} {w}_{i}}{C} , \qquad ( 2 )$$

where C is the number of CPU's in the server.

It should be emphasized that these load functions are exemplary, and other figures of merit may be used, so long as they relate to the number of jobs currently pending or being handled by the server.

Operation.

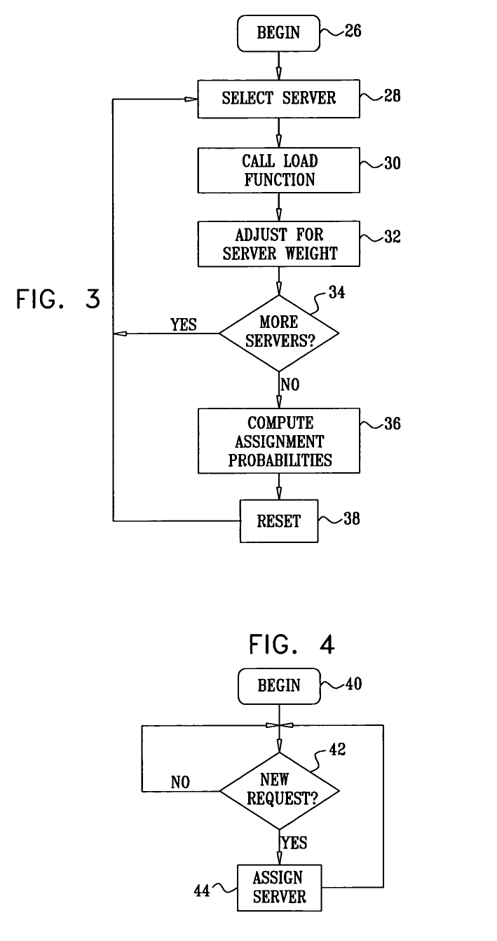

Reference is now made to FIG. 3, which is a flow chart illustrating a method of load-balancing a data network in accordance with a disclosed embodiment of the invention. The process steps are shown in linear sequences for clarity of presentation. However, it will be evident that many of them can be performed in parallel, asynchronously, or in different orders.

At initial step 26, a network, configured with a network dispatcher and a plurality of servers to which tasks can be assigned is in operation. The network can be configured as shown in FIG. 1, and during operation, requests are handled asynchronously. It is assumed that weights have been preassigned to the servers, as described above.

Assessment of server load begins at step 28. One of the servers linked to the network dispatcher is selected.

Next, at step 30, the load function of the current server is read by the network dispatcher.

Next, at step 32, adjustment is made for the preassigned weight of the current server, according to the load function obtained in step 30, which yields an adjusted weight. For example, the value returned at step 30 may be divided by the number of CPU's in the current server.

Control now proceeds to decision step 34, where it is determined if more servers need to be evaluated. If the determination at decision step 34 is affirmative, then control returns to step 28.

If the determination at decision step 34 is affirmative, then a cycle has been completed. Control proceeds to step 36, where weighted server probabilities are computed, according to the adjusted weight of each server, which, as noted above, is a function of both the current load and its capabilities, represented by its pre-assigned weight. The probabilities form the basis for assignment of new tasks.

In some embodiments, the most lightly loaded server is identified. This server will be assigned the task associated with the next request. However, calculating the exact server load and choosing the least loaded server for each request is usually computationally expensive and wastes resources, reducing the servers' total throughput. Therefore an approximation method is preferred, which achieves an almost identical load distribution, but with far less overhead. Instead of evaluating the server weights at each request, it is preferable to process groups of requests. In a short time interval or window, typically 1000 ms, the server weights are kept constant and the requests are distributed probabilistically according to the weight ratios of the servers. It can be done by using a weighted round-robin method. Alternatively, a random number generator can be used in variants of the well-known Monte Carlo technique to select the weighted probabilities. The algorithm used is not critical, so long as the number of requests distributed to each server is approximately proportional to the server's respective weight.

After the time window expires, the weights are revised or updated according to the current metrics being computed by the metric generators. The update can be accomplished by revising the pre-assigned weight values according to the current metrics. Alternatively, the update can be accomplished by readjusting the current adjusted weights.

In the context of asynchronous requests, where the number of requests is relatively small, the metrics should be changed only when a predetermined number of jobs is dispatched or concluded. Alternatively, the weights can be updated upon receipt of a predetermined number of new requests. The predetermined number may be as low as one new request.

The servers are checked repeatedly, as explained above. In any case, after an appropriate delay, at step 38 the server count or index for server selection is reset. Control returns to step 28 to begin a new cycle.

Reference is now made to FIG. 4, which is a flow chart of illustrating a method of distributing new requests using the load balancing method of FIG. 3, in accordance with a disclosed embodiment of the invention. The process begins at initial step 40.

Concurrently with the performance of steps 28-38, the network dispatcher awaits arrival of a new request at delay step 42.

When a new task has arrived, at step 44 the current weighted server load probability distribution, which was computed in the last iteration of step 36, is applied in order to assign a server to service the new task.

Control returns to delay step 42 to await the next task.

### EXAMPLE 1

We have tested the method described above in the following configuration: two HTTP clients posted asynchronous transcription jobs to a cluster of two transcription servers through a network dispatcher (IBM Edge Components 6.0). A typical execution time for each job varied between a few minutes to a full hour. We have used this scenario with fixed weights being assigned to the servers in accordance with their performance capabilities. The results have often been satisfactory, in that the servers emptied their queues at about the same time. For example, when we used a cluster of two identical servers, each server received roughly half of the jobs. However since there is a large variance in the job lengths, and the number of jobs is small, the servers workload differed even though the servers were identical, and the queues on each server were filled with the same number of jobs.

Because no feedback was used, in cases where the weights were biased (e.g., the server was also loaded with other tasks, or the job lengths differed), the distribution of tasks was not optimal, even though the more heavily loaded server received the same number of jobs as the more lightly loaded server. In this case, the lightly loaded server emptied its job queue before the more heavily loaded one.

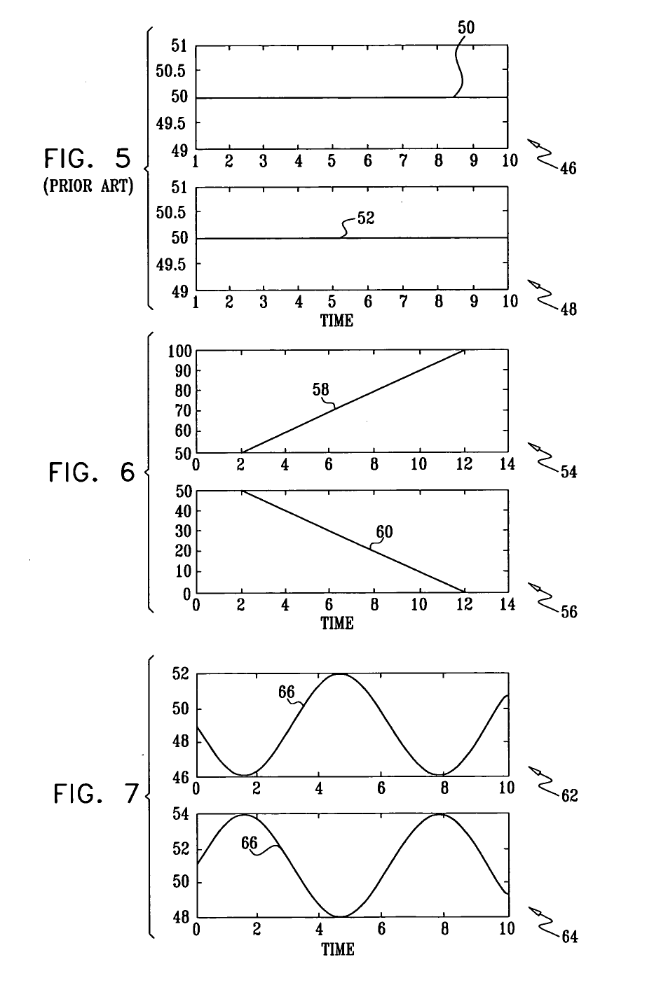

Reference is now made to FIG. 5, which are two graphs 46, 48 of the job distributions over time of the two servers in the above configuration, respectively. As noted, the servers are assigned fixed weights. In both cases the distribution is uniform, as indicated by lines 50, 52. It should be noted that the distributions describe the number of jobs assigned to each of the servers, and not their actual loads.

The graphs 46, 48 also describe a similar testing configuration in which the first server had two CPU's and the second server had one CPU. In this case, the weight assigned to the first server was twice the weight assigned to the second.

Assigning the weights adaptively, using the above-noted conventional metrics available was tried in the above server configuration. We could not stabilize the weights: most of the tasks devolved upon one server, because it had a favorable weight. Since the servers' performance indication was misleading, and it did not vary according to the true server load, a positive feedback was established, which shifted the server weights toward opposite extremes, without regard for the true server load. Reference is now made to FIG. 6, which are two graphs 54, 56 illustrating the job distribution between the two servers over time in which the weights of the servers were varied adaptively. As in FIG. 5, the graph depicts numbers of jobs. In FIG. 6, the lines are intentionally smoothed so that small fluctuations are not seen. It is evident from inspection of lines 58, 60, that the number of jobs diverges rapidly.

Only when we used a feedback metric based on the number of pending jobs, as described above, was it possible to maintain an even distribution of job load among the servers. Reference is now made to FIG. 7, which are two graphs 62, 64 in which the weights of the two servers were adjusted using a feedback metric in accordance with a disclosed embodiment of the invention. The metric chosen reported the number of pending jobs in the queue, and was applicable in that each server in this example had only one execution engine. The meaning of the axes is the same as in FIG. 5. As can be seen from inspection of lines 66, 68, the distribution of jobs of the two servers oscillate narrowly about the servers' relative performance levels, the weights being updated over time.

It will be appreciated by persons skilled in the art that the present invention is not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A computer-implemented method for load-balancing a data network having at least one client connectable thereto and a cluster of servers for servicing said client, said servers each having a job queue and said job queue having a length, the method comprising the steps of;
establishing a connection extending from said client to said cluster of servers;
receiving a request from said client;
in said servers generating respective metrics indicative of currently assigned jobs therein;
responsively to said metrics, assigning weight values to said servers; and
allocating said request to one of said servers according to said weight values for service thereof.

2. The method according to claim 1, further comprising the step of prior to completing said service, terminating said connection.

3. The method according to claim 1, wherein said step of allocating said request comprises computing weighted server probabilities for said servers, and assigning one of said servers to service said request according to said weighted server probabilities.

4. The method according to claim 3, wherein assigning one of said servers is performed using a Monte Carlo method.

5. The method according to claim 1, further comprising the step of identifying a minimally loaded server, and allocating said request is performed by choosing said minimally loaded server.

6. The method according to claim 1, wherein said step of assigning weight values comprises the steps of:
assigning initial weight values to said servers that are indicative of respective capabilities thereof; and
adjusting said initial weight values according to said metrics.

7. The method according to claim 6, wherein said step of assigning weight values is performed periodically at predetermined intervals.

8. The method according to claim 6, wherein said step of assigning weight values is performed repeatedly after completion of a predetermined number of requests.

9. The method according to claim 6, wherein said step of assigning weight values is performed repeatedly after receiving a predetermined number of requests.

10. The method according to claim 1, wherein said metrics comprise a function of said length of said job queue.

11. The method according to claim 1, wherein said servers comprise a plurality of execution engines, and generating respective metrics comprises the steps of:
assigning respective workload weights to said execution engines that are indicative of server resources consumed by said execution engines; and
multiplying a number of tasks currently assigned to each of said execution engines by said respective workload weights.

12. A computer software product for load-balancing a data network having at least one client connectable thereto and a cluster of servers for servicing said client, the product including a computer-readable medium in which computer program instructions are stored, which instructions, when read by a computer, cause the computer to establish a connection extending from said client to said cluster of servers, to receive a request from said client, to receive from said servers respective metrics indicative of currently assigned jobs therein, responsively to said metrics, to assign weight values to said servers, and to allocate said request to one of said servers according to said weight values for service thereof.

13. The computer software product according to claim 12, wherein said instructions further cause said computer to terminate said connection prior to completing said service.

14. The computer software product according to claim 12, wherein said instructions further cause said computer to compute weighted server probabilities for said servers, and to assign one of said servers to service said request according to said weighted server probabilities.

15. The computer software product according to claim 12, wherein said instructions further cause said computer to assign initial weight values to said servers that are indicative of respective capabilities thereof, and to adjust said initial weight values according to said metrics.

16. The computer software product according to claim 15, wherein said instructions further cause said computer to assign weight values periodically at predetermined intervals.

17. The computer software product according to claim 15, wherein said instructions further cause said computer to assign weight values repeatedly after completion of a predetermined number of requests.

18. A network dispatcher for load-balancing a data network having at least one client connectable thereto and a plurality of servers for servicing said client, comprising a processor operative to receive a request from said client, to receive from said servers respective metrics indicative of currently assigned jobs therein, responsively to said metrics, to assign weight values to said servers; and to allocate said request to one of said servers according to said weight values for service thereof.

19. The network dispatcher according to claim 18, wherein said processor is further operative to assign initial weight values to said servers that are indicative of respective capabilities thereof; and to adjust said initial weight values according to said metrics.

20. The network dispatcher according to claim 18, wherein said processor is operative to compute weighted server probabilities for said servers, and to assign one of said servers to service said request according to said weighted server probabilities.
